(19) United States
(12) Patent Application Publication
(10) Pub. No.: US 2026/0097714 A1
(43) Pub. Date: Apr. 9, 2026

(54) UTILITY BOX FOR PLACEMENT UNDER TOW AND RECOVERY VEHICLES

(71) Applicant: Phoenix USA., Inc., Cookeville, TN (US)

(72) Inventor: Barry Lynn Roberts, Cookeville, TN (US)

(21) Appl. No.: 19/354,626

(22) Filed: Oct. 9, 2025

Related U.S. Application Data
(60) Provisional application No. 63/705,395, filed on Oct. 9, 2024.

(51) Int. Cl. B60R 9/02; B60R 11/06

(52) U.S. Cl. CPC B60R 9/02; B60R 11/06

(57) ABSTRACT

The present invention provides a utility box designed for mounting to the underside of tow and recovery vehicles, particularly those featuring a flatbed. The utility box comprises a main container body defined by a bottom wall, first and second side walls, a rear wall, an upper wall, and a front wall that creates an opening for access to the interior storage space. A panel is pivotally coupled to the main container body, allowing it to selectively cover the front wall and opening, thus ensuring the protection of the stored items from the elements and unauthorized access. Additionally, the utility box is equipped with a bracket assembly that securely attaches the main container body to the underside of the vehicle, providing stability during transit. This innovative design enhances the organization, accessibility, and security of tools and equipment, significantly improving the efficiency of towing and recovery operations.

This is a non-provisional patent application claiming priority to co-pending U.S. Provisional Patent Application Ser. No. 63/705,395 filed by Phoenix USA., Inc. for an invention by Barry Lynn Roberts, a permanent resident of the United States residing in Cookeville, Tennessee, for the invention entitled “Utility Box For Placement Under Tow and Recovery Vehicles,” which is hereby incorporated by reference in its entirety.

### BACKGROUND

### 1. Field of the Invention

The present invention pertains to utility boxes designed for placement under flatbed tow and recovery vehicles. More specifically, it relates to a robust and versatile utility box that provides efficient storage solutions for tools, equipment, and supplies essential for towing and recovery operations. The utility box is engineered to fit seamlessly beneath the flatbed, maximizing space utilization while ensuring easy access to stored items. This invention addresses the unique challenges faced by tow operators, such as the need for organized storage that can withstand harsh environmental conditions, as well as the necessity for quick retrieval of tools and equipment during emergency situations. By enhancing the functionality and accessibility of storage in flatbed vehicles, this utility box aims to improve the efficiency and safety of towing and recovery activities.

### 2. Description of the Prior Art

Towing and recovery operations are critical in various industries, including automotive repair, emergency services, and roadside assistance. Tow and recovery vehicles, particularly those with flatbed designs, play a vital role in transporting disabled or damaged vehicles. These vehicles require efficient storage solutions for tools, equipment, and supplies necessary for effective operation.

Traditionally, towing professionals have relied on external storage containers or equipment stored in the vehicle cab, which can lead to several challenges. External storage options are often subject to theft, damage from weather conditions, and may not provide adequate protection for tools and supplies. Additionally, storing equipment in the vehicle cab can create clutter and hinder quick access during time-sensitive recovery situations.

Current solutions for storage in flatbed tow vehicles typically lack organization, accessibility, and durability. Many existing utility boxes are not designed to fit securely under the flatbed, leading to wasted space and potential safety hazards. Furthermore, the need for quick retrieval of tools during emergencies makes it essential for any storage solution to be easily accessible while maintaining a secure structure.

The present invention addresses these shortcomings by providing a dedicated utility box that is specifically designed for placement beneath flatbed tow and recovery vehicles. This utility box optimizes space utilization, enhances organization, and ensures that essential tools and equipment are readily available, thus improving the overall efficiency and safety of towing and recovery operations.

### BRIEF SUMMARY

In view of at least some of the above-referenced problems associated with storage options for tow and recovery vehicles, an exemplary object of the present disclosure may be to provide a utility box specifically engineered for mounting beneath tow and recovery vehicles, particularly those equipped with a flatbed. This utility box offers a practical solution for storing essential tools and equipment, enhancing operational efficiency and safety during towing and recovery tasks. By featuring a main container body with a protective front opening, along with a pivotally coupled panel for easy access, the design ensures that stored items are both secure and readily available. Additionally, the robust bracket assembly facilitates secure attachment to the vehicle's underside, optimizing space utilization while maintaining stability during transport. Overall, this utility box addresses the challenges faced by towing professionals, providing an organized and accessible storage solution tailored to their needs.

### BRIEF DESCRIPTION OF THE SEVERAL VIEWS OF THE DRAWINGS

FIG. 1 is a front view of an embodiment of a utility box mounted to the underside of a tow and recovery vehicle in accordance with the present disclosure.

FIG. 2 is a perspective view of a main container body of the utility box of FIG. 1 in accordance with the present disclosure.

FIG. 3 is a perspective view of various parts of a bracket assembly of the utility box of FIG. 1 in accordance with the present disclosure.

FIGS. 4-10 are perspective views of an installation process of the main container body of FIG. 2 and the bracket assembly of FIG. 3 to the underside of the tow and recovery vehicle in accordance with the present disclosure.

FIG. 11 is a rear perspective view of another embodiment of the utility box mounted to the underside of the tow and recovery vehicle in accordance with the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

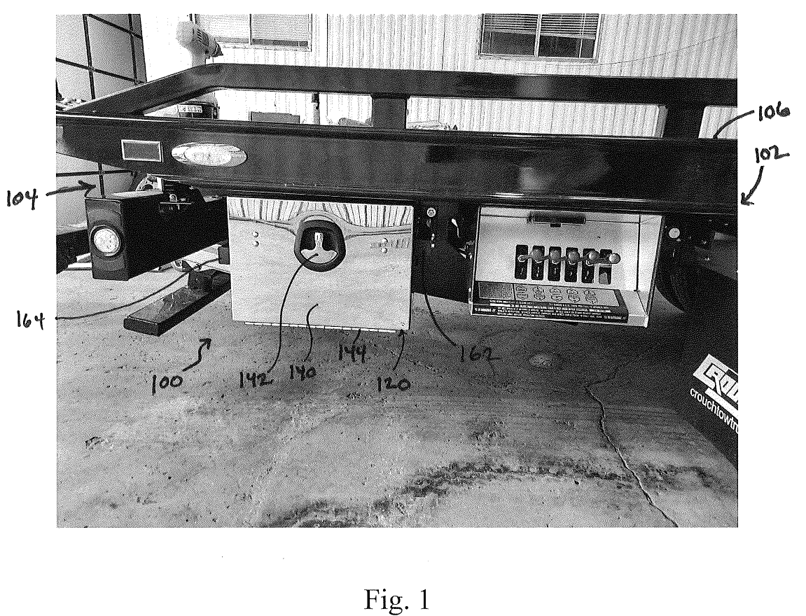

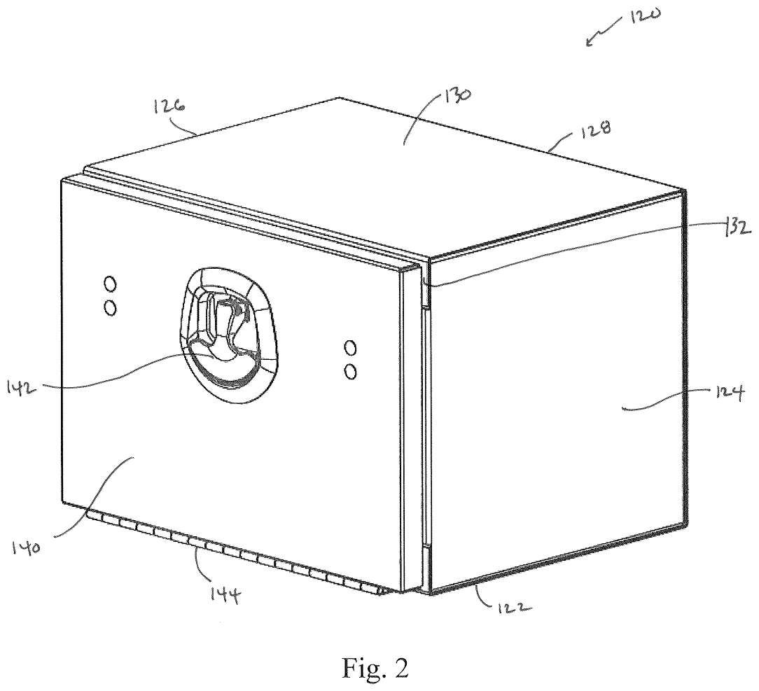

Referring to FIG. 1, a utility box 100 is provided for mounting to an underside 104 of a tow and recovery vehicle 102. The tow and recover vehicle 102 may include a flatbed 106. The utility box 100 may be mounted to the underside 104 of the flatbed 106. The utility box 100 may include a main container body 120, a panel 140, and a bracket assembly 160. As illustrated in FIGS. 1-2, the main container body may include a bottom wall 122, a first side wall 124, a second side wall 126, a rear wall 128, an upper wall 130, and a front wall 132 defining an opening 134. The panel 140 may also be referred to herein as a door 140. The panel 140 may be coupled to the main container body 120 and may be configured to selectively cover the opening 134 and at least a portion of the front wall 132. The panel 140 may include a latch 142 configure to hold the panel in a closed position when desired. The panel 140 or latch 142 may include a lock assembly for enabling secure storage of tools, equipment, and supplies in the main container body 120. The bracket assembly 160 may be configured to couple the main container body 120 to the underside 104 of the tow and recovery vehicle 102.

In certain optional embodiments, the panel 140 may be pivotally coupled to the front wall 132 proximate to the bottom wall 122, for example using a hinge 144. In other optional embodiments, the panel 140 may be coupled to the front wall 132 proximate to the first side wall 124. In further optional embodiments, the panel 140 may be coupled to the front wall 132 proximate to the second side wall 126. In still further optional embodiments, the panel 140 may be coupled to the front wall 132 proximate to the upper wall 130. When coupled to the upper wall 130, the panel 140 may further include one or more gas struts configured to support the panel 140 when in an open position.

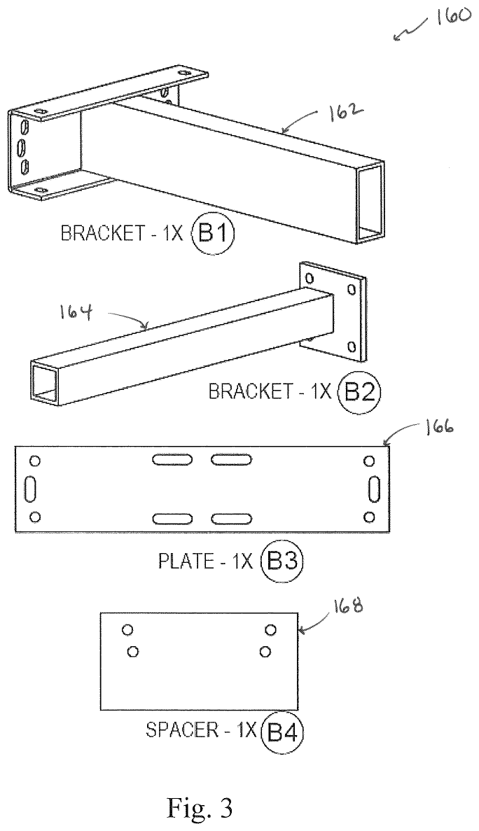

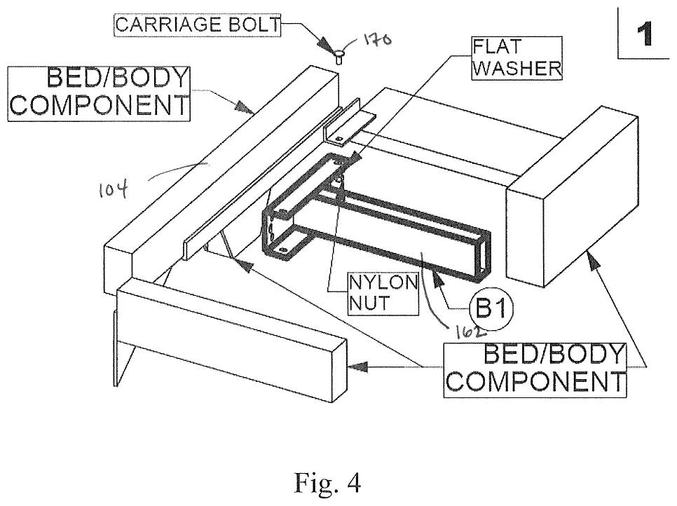

As illustrated in FIG. 3, the bracket assembly 160 may include one or more of a first bracket arm 162, a second bracket arm 164, a mounting plate 166, and/or a spacer plate 168. As illustrated in FIGS. 4-11, the bracket assembly 160 may further include a plurality of fasteners 170. The plurality of fasteners 170 may include, for example, nuts, bolts, screws, lock washers, and the like. Each of the first bracket arm 162 and the second bracket arm 164 may include a post and a base plate. The base plate may be flat, channel shaped, or the like. The post may generally have a square or rectangular profile. As illustrated in FIG. 1, the first bracket arm 162 may be configured to be coupled to and support the first side wall 124 of the main container body 120, and the second bracket arm 164 may be configured to be coupled to and support the second side wall 126 of the main container body 120.

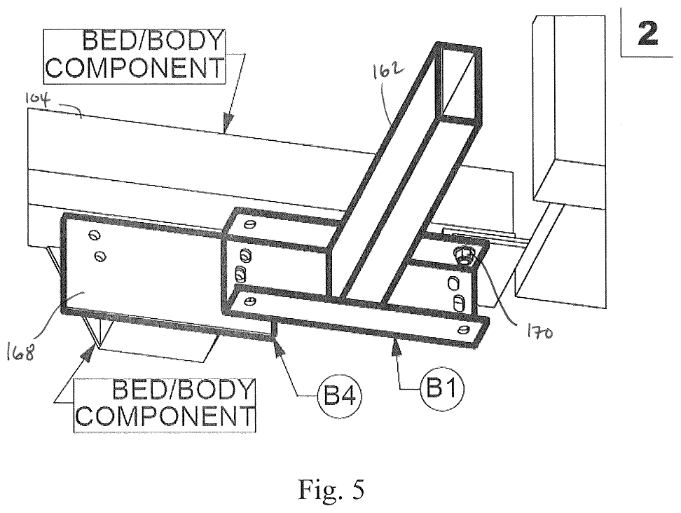

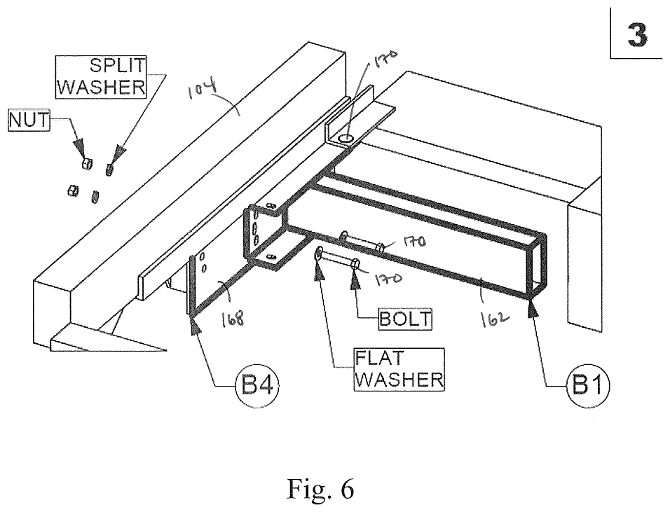

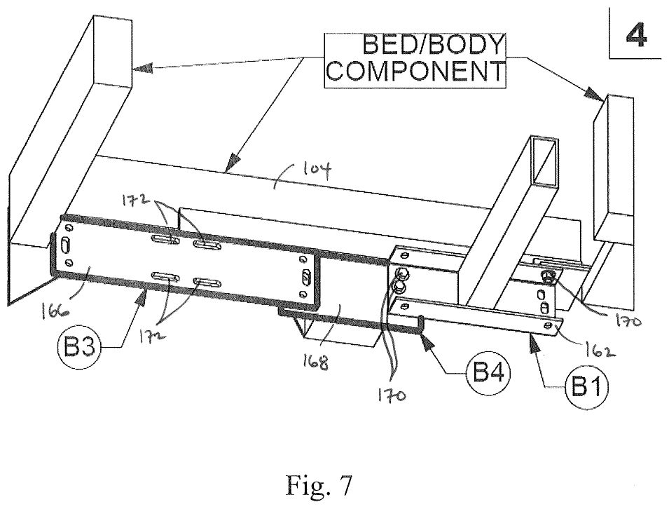

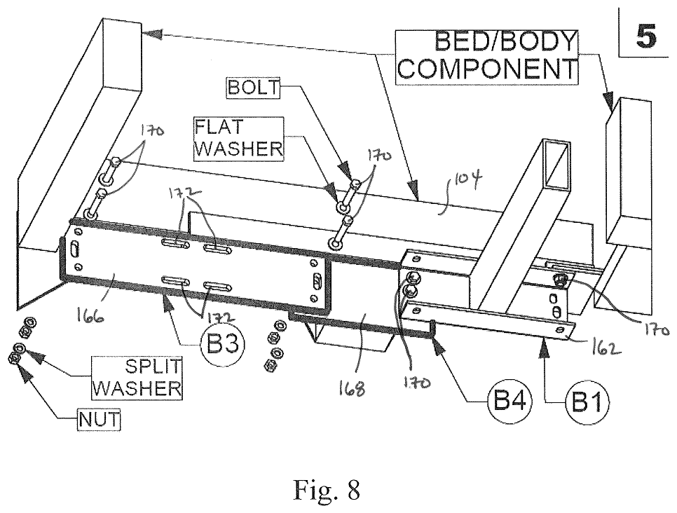

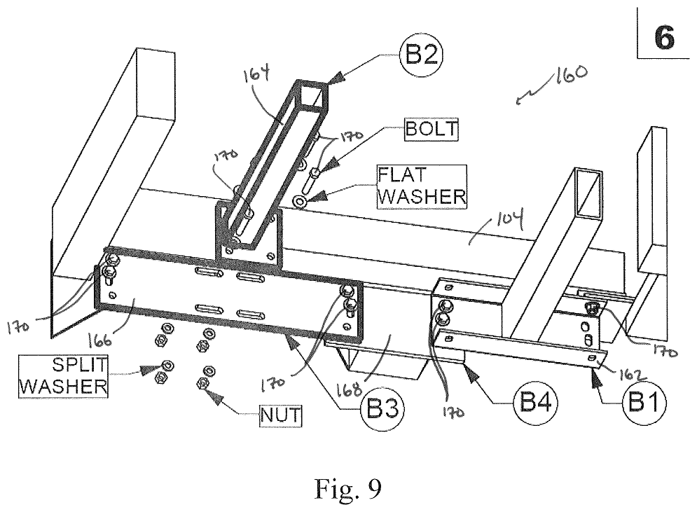

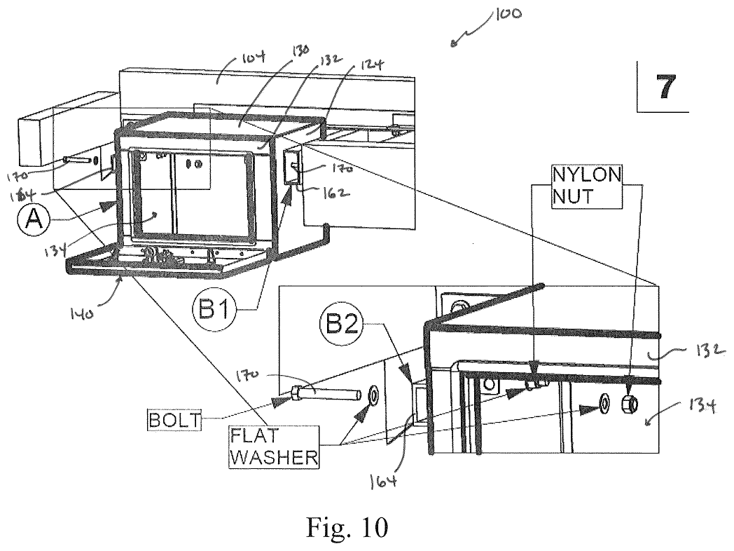

Referring to FIGS. 4-10, steps of installing the utility box 100 to the underside 104 of the tow and recovery vehicle 102. As illustrated in FIG. 4, the first bracket arm 162 (e.g., base plate) may be installed directly to a bed or body member of the underside 104 of the tow and recovery vehicle 102 using one or more of the plurality of fasteners 170. Holes may need to be drilled for installation. As illustrated in FIG. 5, a first portion of the spacer plate 168 may be positioned behind the first bracket arm 162. As illustrated in FIG. 6, the spacer plate 168 may be coupled to the first bracket arm 162 using one or more of the plurality of fasteners 170. As illustrated in FIG. 7, a portion of the mounting plate 166 may be positioned in front of a second portion of the spacer plate 168. As illustrated in FIG. 8, the mounting plate 166 may be coupled to each of the spacer plate 168 and the underside 104 of the tow and recovery vehicle 102 using one or more of the plurality of fasteners 170. As illustrated in FIG. 9, the second bracket arm 164 (e.g., the base plate) may be coupled to the mounting plate 166 using one or more of the plurality of fasteners 170. In particular, the second bracket arm 164 may include a plurality of slots 172 configured to receive one or more of the plurality of fasteners 170 for coupling the second bracket arm 164 to the mounting plate 166. The plurality of slots 172 enable lateral adjustment of the second bracket arm 164 relative to the first bracket arm 162. As illustrated in FIG. 10, the main container body 120 may be positioned between and coupled to the first and second bracket arms 162, 164 using one or more of the plurality of fasteners 170.

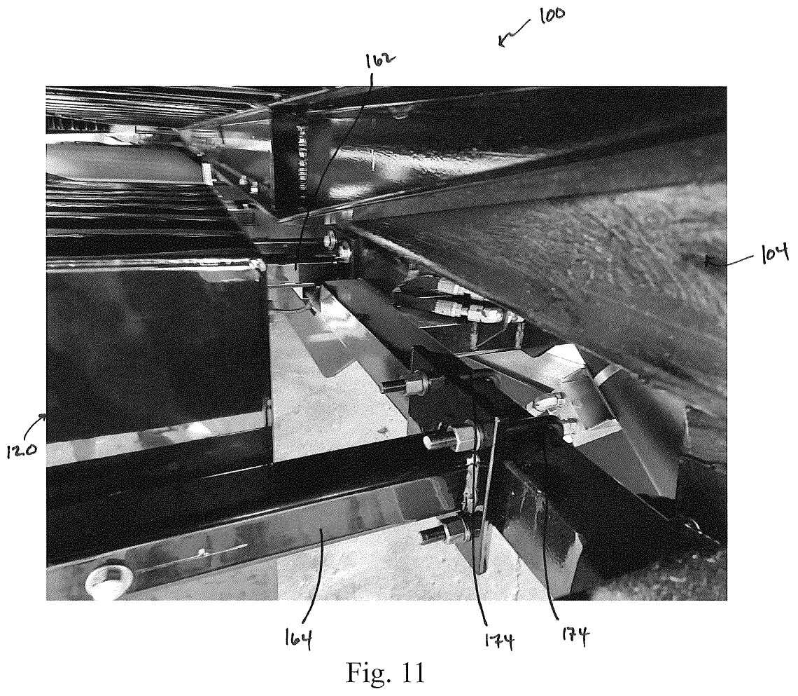

Referring to FIG. 11, an alternative embodiment of how the second bracket arm 164 may be attached directly to the underside 104 of the tow and recovery vehicle 102 is illustrated. Specifically, the second bracket arm 164 may be coupled directly to the underside 104 of the tow and recovery vehicle 102 using one or more U-bolts 174 of the backet assembly 160.

Since the underside 104 of different tow and recovery vehicles may be different and mounting locations and relative heights of the first and second bracket arms 162, 164 may be different, the first and second bracket arms 162, 164 and the main container body 120 may be custom drilled for installation of the main container body 120 to the first and second bracket arms 162, 164.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Although embodiments of the present invention have been described in detail, it will be understood by those skilled in the art that various modifications can be made therein without departing from the spirit and scope of the invention as set forth in the appended claims.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. A utility box for mounting to an underside of a tow and recovery vehicle, the utility box comprising:
a main container body including a bottom wall, first and second side walls, a rear wall, an upper wall, and a front wall defining an opening;
a panel pivotally coupled to the main container body and configured to selectively cover the front wall and the opening; and
a bracket assembly configured to couple the main container body to the underside of the tow and recovery vehicle.

2. The utility box of claim 1, wherein:
the bracket assembly includes a first bracket arm and a second backet arm, the first bracket arm configured to be coupled to the first side wall of the main container body, and the second bracket arm configured to be coupled to the second side wall of the main container body.

3. The utility box of claim 2, wherein:
the bracket assembly further includes a mounting plate configured to be coupled to the underside of the tow and recovery vehicle, the mounting plate further configured to receive the second bracket arm.

4. The utility box of claim 3, wherein:
the mounting plate includes a plurality of slots for adjustably receiving and positioning the second bracket arm.

5. The utility box of claim 3, wherein:
The bracket assembly further includes a spacer plate configured to function as a linkage between the mounting plate and the first bracket arm.

6. The utility box of claim 2, wherein:
the first bracket arm is configured to be connected directly to the underside of the tow and recovery vehicle using one or more fasteners.

7. The utility box of claim 2, wherein:
the second bracket arm is configured to be connected directly to the underside of the tow and recovery vehicle using one or more fasteners.
